(19) United States
(12) Patent Application Publication
(10) Pub. No.: US 2004/0187317 A1
(43) Pub. Date: Sep. 30, 2004

(54) Method of removing crust from bread

(76) Inventor: Michele Wood, Swarthmore, PA (US)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/396,072

(22) Filed: Mar. 25, 2003

(51) Int. Cl. B26D 1/00

(52) U.S. Cl. 30/315; 83/13

(57) ABSTRACT

Provided is a method of removing crusts from bread with minimum waste. The method comprises the steps of providing a bread slice having a crust. The crust has a width, a contour and a size. A crust trimmer is also provided. The crust trimmer has a cutting edge, and the cutting edge has a contour that is similar to the contour of the crust. The size of the cutting edge differs from the size of the crust by the width of the crust. The contour of the cutting edge is aligned with the contour of the bread slice, and the crust is removed from the bread slice, preferably by pushing the cutting edge through the bread slice.

### BACKGROUND OF THE INVENTION

1. Field of the Invention

The present invention relates to the field of food preparation, specifically to improving the taste, texture, or appearance of foods comprising bread.

2. Description of the Related Technology

Often, it is desirable to remove the crust from bread, for reasons relating to improving the bread or a food that includes the bread. For example, removing bread crusts results in a lighter and more refined bread or food, and a more uniform taste, texture or color. Foods that may preferably be made with crustless bread include, for example, bread crumbs; foods that are coated with bread crumbs, such as fried chicken, fish sticks, croquettes, and the like; meatballs, meat loaf, and the like; and desserts, such as summer pudding, bread pudding, and the like.

In particular, many people prefer to eat sandwiches that are made from bread without crusts. Again, this preference stems from desire for more refined or formal foods, such as tea sandwiches or finger sandwiches, for example.

Typically, crusts are removed by cutting them from the bread with a knife. Kitchen knives, however, make straight cuts that do not conform to the cross section of a commercial loaf of bread. The edges of a slice from a commercial bread loaf are usually curved. Thus, in order to remove all of the crust, the bread must be cut in a slow and tedious jigsaw fashion that follows the contour of the crust. Alternatively, the bread can be cut along straight lines determined by the innermost points of the curves in the crust. This method removes all of the crust relatively quickly; however, it is wasteful because an inordinate portion of the inner, crustless bread is discarded together with the unwanted crusts.

Children, although they typically enjoy sandwiches and may include one or more: sandwiches in their daily diet, are especially likely to share a preference for crustless bread. Children are often: incapable of preparing their own meals, however. Therefore, a child's parent or another caregiver must laboriously remove the crusts from the child's sandwich. When a parent or caregiver is responsible for preparing meals for a group of children, removing the crusts from many sandwiches can become an impractical burden.

Furthermore, some children would be able to prepare a sandwich, remove its crusts, and cut the sandwich into serving portions, if a safe alternative to kitchen knives were available. In addition, there are other people: who may not wish to handle a sharp knife. For example, people who are not able to grasp a knife firmly or move it steadily, such as those who suffer from arthritis or Parkinson's disease, would also benefit from safer means to remove the crusts from bread, or to cut it into serving portions.

Other devices and methods for cutting bread and other foods are known. For example, U.S. Pat. No. 1,741,682 describes a device for cutting slices of food, such as vegetables, pastry, and bread, into decorative patterns.

U.S. Pat. No. 4,345,516 describes a kitchen tool including a ring. The ring has a flat edge and a cutting edge. Using this tool, an egg may be cooked on a grill while contained within the ring, and other foods may be cut to the same size as the cooked egg.

U.S. Pat. No. 4,352,242 describes a hollow tube with a sharpened end. Food cut with the sharpened end accumulates within the tube. A skewer is inserted through the accumulated food, and the skewered food is released from the tube by exerting an ejecting force on the skewer.

U.S. Pat. No. 4,507,866 describes a tool for creating holes in bread rolls. The tool includes a hollow tube with a sharpened end. The tube is inserted into the roll by cutting through the roll. The cut portion is severed and removed from the roll inside the tube.

U.S. Pat. No. 6,052,910 describes a vegetable cutting device for cutting vegetables into shaped portions.

Finally, commercially prepared crustless bread has recently become available to consumers. Commercially prepared crustless bread is more expensive than bread with crusts, however, and it is not available in the same wide variety as bread with crusts.

None of these devices and methods, however, provides a simple and efficient means of removing crusts from bread with minimal waste. Nor is a device or method provided to aid people who do not wish to handle a knife in removing crusts from bread, or for cutting bread into serving portions.

Therefore, there remains a need for a means of removing crusts from bread that is simple and efficient, that minimizes the waste of crustless bread, that allows the consumer to choose from a wide range of commercially available or home-prepared breads, and that aids people who do not~ wish to handle a knife in removing crusts from bread, and in cutting bread into serving portions. SUMMARY OF THE INVENTION

Accordingly, it is an object of the invention to provide a means for removing crusts from bread that is simple and efficient, that minimizes the waste of crustless bread, that allows the consumer to choose from a wide range of commercially available, or home-prepared breads and that aids people who do not wish to handle a knife in removing crusts from bread,; and in cutting bread into serving portions.

In order to achieve the above and other objects of the invention, a method for removing crusts from bread with minimum waste is provided. In one aspect of the invention, the method comprises providing a bread slice having a crust. The crust has a width, a contour and a size. A crust trimmer is also provided. The crust trimmer has a cutting edge, and the cutting edge has a contour that is similar to the contour of the crust. The size of the cutting edge differs from the size of the crust by the width of the crust. In the method of the invention, the contour of the cutting edge is aligned with the contour of the bread slice, and the crust is removed from the bread slice.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of the crust trimmer.

FIG. 2 is a perspective view of the crust trimmer engaged with a bread slice.

FIG. 3 is a side view of the crust trimmer.

FIG. 4 is an orthogonal side view of the crust trimmer.

FIG. 5 is a top plan view of a crust trimmer.

FIG. 6 is a top plan view of a different embodiment of a crust trimmer.

### DETAILED DESCRIPTION OF THE PREFERRED EMBODIMENTS

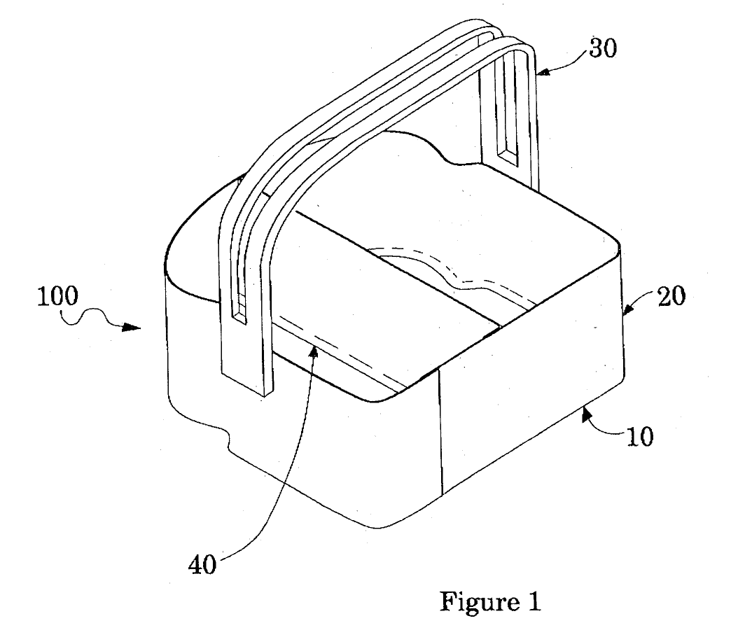

Referring now to the drawings, wherein like reference numerals designate corresponding structure throughout the views, and referring in particular to FIG. 1, a crust trimmer 100 suitable for use in the methods of the invention is depicted. The cutting edge 10, the body 20, the handle 30, and the additional blade 40 of the crust trimmer 100 are shown in FIG. 1.

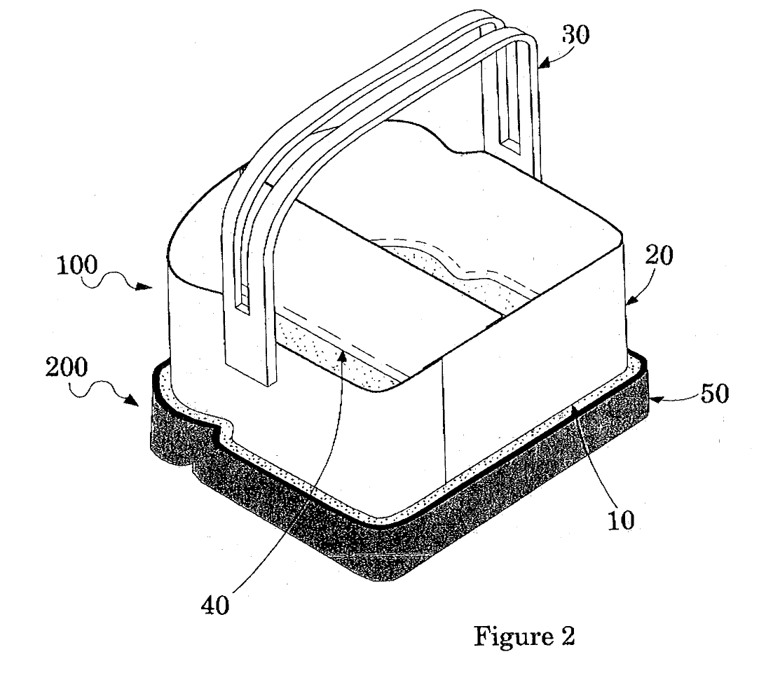

Referring now to FIG. 2, the cutting edge 10 of the crust trimmer 100 has a contour that is substantially similar to that of the bread slice 200 from which it is desired to remove the crust 50. The size of the cutting edge 10 is smaller than the size of the bread slice 200. Preferably, the size of the cutting edge 10 differs from the size of the bread slice 200 by the width of the crust 50.

The term “contour”, as used herein, refers to the shape or outline of an object.

The term “similar”, as used herein, refers to shapes or outlines that differ in size only.

The term “width of the crust”, as used herein, refers to the distance between the outer edge of the crust 50 and a point in the interior of the bread 200 that has not been perceptibly browned by the baking of the bread. This distance is typically in the range of about 0.1 mm to about 0.5 mm.

In one embodiment of the method of the invention, therefore, a slice of bread 200 having a crust 50 and a crust trimmer 100 with a cutting edge 10 are provided. The crust trimmer 100 is aligned with the bread slice 200 so that the contour of the cutting edge 10 is most nearly parallel to the crust 50 of the bread slice 200. Preferably, the crust 50 is removed by applying pressure to the crust trimmer 100 to cut through the bread slice 200. Preferably, the pressure is applied by hand.

The crust trimmer 100 may be used advantageously to remove the crusts 50 from bread slices 200 taken from loaves prepared by large commercial bakeries. Bread slices 200 taken from these loaves generally have a standard shape and size.

Two common standard loaf shapes are referred to herein as “family-sized” and “country” loaves. For example, white bread prepared by large commercial bakeries usually appears in a family-sized loaf. Bread slices 200 from a family-sized loaf have a profile that is approximately square, often with a curve at the top where the dough has expanded over the top edge of the pan during baking. White bread, whole wheat bread, and potato bread are often baked in country loaves, in which the bread slices 200 are usually shorter and wider than those in a typical family-sized loaf.

There may be some variation in size and contour among bread slices 200 prepared by large commercial bakeries. Also, bread loaves prepared by smaller bakeries may not conform exactly to an industry standard.

In this connection, dimensions, sizes, tolerances, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, parameter, shape or other quantity or characteristic is “about” or “approximate” as used herein, whether or not expressly stated to be such.

The crust trimmer 100 used in the methods of the invention may be fabricated from any suitable material or materials. In general, the material of the cutting edge 10 may be sharpened, tapered, serrated, or altered in like fashion to facilitate cutting the crusts from the bread slice. When a body 20 is included, its material must be sufficiently stiff so that adequate force to cut through a bread slice can be applied to the cutting edge 10. Like considerations apply to the construction of the additional blade 40.

The crust trimmer 100 is preferably made of metal, plastic, or a combination of metal and plastic. For example, a crust trimmer 100 may include a body 20 made of plastic and a cutting edge 10 made of metal. A preferred crust trimmer 100 is made of metal.

Still referring to FIG. 2, the crust trimmer 100 may advantageously include a body 20. The body 20 serves to strengthen and stabilize the cutting edge 10.

In addition, the height of the body 20 can be varied to accommodate more than one bread slice 200. In these embodiments, the crust trimmer 100 may be used advantageously to remove the crusts 50 from a stack including more than one bread slice 200, for example, from a sandwich, or from a plurality of sandwiches. As the height of the body 20 is increased, the crust trimmer 100 will be able to remove the crusts 50 from stacks of increasing height. The stacks of food will also remain aligned after the crusts 50 have been removed. When the method of the invention is used to remove the crust 50 from a sandwich, the sandwich filling is also trimmed to the size of the crustless bread, providing an additional advantage.

When the crust trimmer 100 includes a body 20, it is preferable that the cutting edge 10 and the body 20 be formed of the same material. The cutting edge 10 is more preferably integral with the body 20. In the case of an integral body 20, if the thickness of the body 20 is such that the crust trimmer 100 cannot remove the crusts 50, the cutting edge 10 may be formed on the body 20 by sharpening.

The body 20, however, may be made of a different material from the cutting edge 10. For example, the body 20 may be formed of plastic or wood, and the cutting edge 10 may be made of metal. Such a design may provide for economies in manufacturing costs.

Also, the body 20 may be permanently or removably attached to the cutting edge 10. Examples of permanent attachment include riveting, gluing, welding, soldering, interlocking, and the like. Examples of means of removable attachment include magnetic attachment, attachment by friction, temporary interlocking as by clips, and the like.

Preferably, suitable stops are included to stabilize the body 20 when it is removably attached to the cutting edge 10. Clips are an example of temporary interlocking mechanism with a suitable stop. In one example of a clip, a protrusion on the body 20 is designed to be seated in a cavity in the cutting edge 10. Preferably, the protrusion is conveniently removable from the cavity, for example by the application of pressure by hand. Appropriately placed magnets are another example of a suitable stop.

In a preferred embodiment, the body 20 is provided with a slot into which the cutting edge 10 is fitted. The cutting edge 10 may be held in the slot removably, as by friction, or permanently, as by gluing, or by riveting through the body 20 and the cutting edge 10.

Still referring to FIG. 2, the crust trimmer 100 may advantageously be provided with a handle 30. The handle 30 may be fabricated in any functional size. Preferably, the handle 30 is sized so that it may be grasped comfortably by hand. That is, preferably, the handle 30 is sufficiently high so that the user's fingers clear the other parts of the crust trimmer 100, and sufficiently wide so that it will accommodate four fingers or the palm of a hand.

The handle 30 may be formed integrally with the crust trimmer 100, or it may be permanently or removably connected to the body 20. Some examples of suitable means of permanent and removable attachment are set forth above. Preferably, suitable stops are included to stabilize the handle 30 when it is removably attached to the crust trimmer 100. Some examples of suitable stops are also set forth above.

The handle 30 may be made from the same material as the cutting edge or the body, or it may be made from a different material. For example, the handle 30 may be made from wood or plastic, and the cutting edge 10 or body 20 may be made from metal. As noted above with respect to the body 20, including a variety of materials in the crust trimmer 100 may provide for economies in manufacturing costs. The material and construction of the handle 30, and its connection to the body 20, are suitable if the handle 30 is capable of transferring to the body 20 the force necessary to cut the crust 50 from the bread slice 200. Preferably, the handle 30 is made from the same material as the body 20.

In alternative embodiments of the invention, the handle 30 may take forms other than the U-shape shown in FIG. 2. For example, the handle 30 may take the form of one or more knobs connected to the body 20 so as to distribute the exerted force as evenly as possible over the cutting edge 10. The handle 30 may also be formed integrally with the body. For example, the top edge of body 20 may be rolled over so that pressure may be applied comfortably to the crust trimmer 100 with the flat of the hand.

Still referring to FIG. 2, the crust trimmer 100 may optionally be equipped with an additional blade 40. In the embodiment depicted in FIG. 1, a preferred additional blade 40 is designed to halve a bread slice 200 simultaneously with the removal of the crust 50. The additional blade 40 is preferably included when the bread slice 200 is part of a sandwich.

It is apparent that more than one additional blade 40 may be included in the crust trimmer 100. For example, orthogonal additional blades 40 will cut a bread slice 200 into quarters, and parallel additional blades 40 will cut a bread slice 200 into strips, as for finger sandwiches. Other configurations that produce useful or pleasing results will be apparent to those of skill in the art.

The additional blade 40 may be formed integrally with the crust trimmer 100, or it may be permanently or removably attached to the crust trimmer 100. Some examples of suitable means of permanent and removable attachment are set forth above. Preferably, suitable stops are included to stabilize the additional blade 40 when it is removably attached to the crust trimmer 100. Some examples of suitable stops are also set forth above.

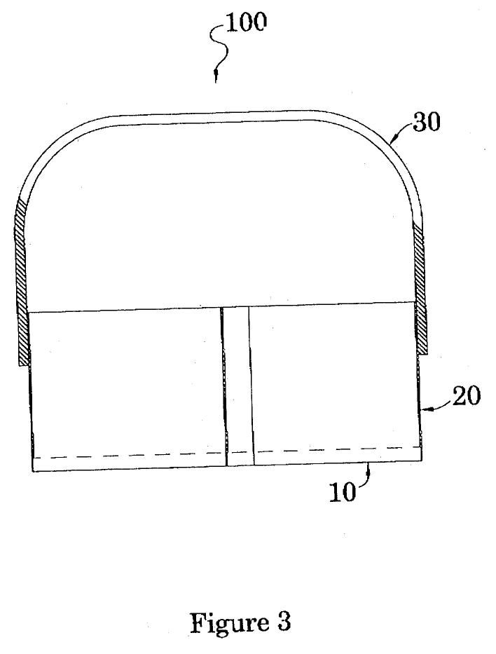

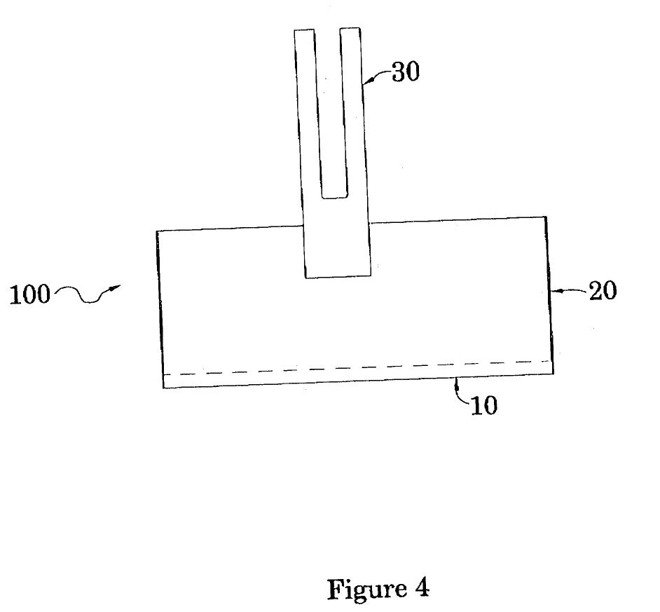

FIGS. 3 and 4 are side views of the crust trimmer 100. Depicted are the body 20, the handle 30, and the cutting edge 10. The viewing angle of FIG. 3 is perpendicular to that of FIG. 2.

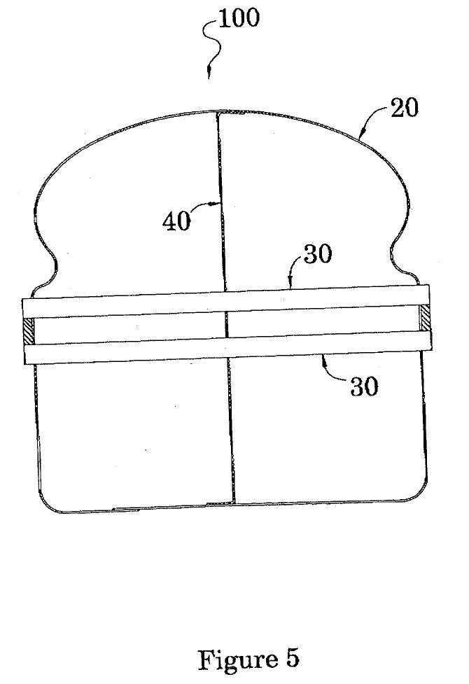

FIG. 5 is a top plan view of a preferred embodiment of a crust trimmer 100. In this embodiment, the cutting edge 10 and body 20 have a contour that is typical of the cross-section of commonly available “family-sized” loaves of bread.

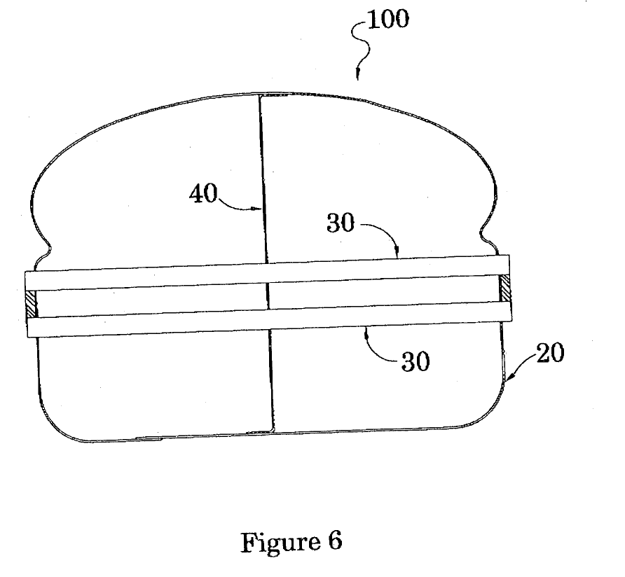

FIG. 6 is a top plan view of another preferred embodiment of a crust trimmer 100. In this embodiment, the cutting edge 10 and body 20 have a contour that is typical of the cross-section of a “country” loaf.

In a preferred embodiment, the cutting edge 10 may include two or more adjustably connected portions, so that its contour may be changed by moving the portions relative to one another.

In another preferred embodiment, the body 20, the handle 30, and/or the additional blade 40 may also be formed from two or more adjustably connected portions, so that their size will also change to accommodate the re-sizing of the cutting edge 10. The adjustable portions may be, for example, slidably connected. Preferably, suitable stops and/or clips are included to stabilize the crust trimmer 100 in the chosen configuration. In such an embodiment, for example, the family loaf-sized contour of the crust trimmer 100 shown in FIG. 4 can be converted to the country loaf-sized contour of the crust trimmer 100 shown in FIG. 5 by moving the pieces of the cutting edge 10 appropriately with respect to each other.

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method for removing crusts from bread with minimum waste, comprising:
providing a bread slice, the bread slice having a crust, the crust having a width, a contour and a size;
providing a crust trimmer, the crust trimmer comprising a cutting edge, the cutting edge having a contour that is similar to the contour of the crust, and a size that differs from the size of the crust by the width of the crust;
aligning the contour of the cutting edge with the contour of the bread slice; and
removing the crust from the bread slice.

2. The method of claim 1, wherein the crust is removed by pushing the cutting edge through the bread slice.

3. The method of claim 1, wherein the contour of the bread slice and the contour of the cutting edge are substantially similar to the profile of a family loaf.

4. The method of claim 1, wherein the contour of the bread slice and the contour of the cutting edge are substantially similar to the profile of a country loaf.

5. The method of claim 1, wherein the crust trimmer further comprises a body, a handle, or a body and a handle.

6. The method of claim 5, wherein the crust trimmer comprises the body, and wherein the body can accommodate a stack comprising more than one bread slice.

7. The method of claim 5, wherein the cutting edge and the body, the handle, or the body and the handle comprise adjustably connected portions for changing the contour of the cutting edge.

8. The method of claim 7, wherein the contour of the cutting edge can be changed reversibly between the contour of a slice of a family-sized loaf and the contour of a slice of a country loaf.

9. The method of claim 1, wherein the crust trimmer further comprises an additional blade connected to the cutting edge.

10. The method of claim 9, wherein the additional blade is integrally formed with or permanently attached to the crust trimmer.

11. The method of claim 9, wherein the additional blade is removably attached to the crust trimmer.

12. The method of claim 9, wherein the additional blade halves the bread slice.

13. The method of claim 1, wherein the crust trimmer further comprises a body connected to the cutting edge, a handle connected to the cutting edge or to the body, and an additional blade connected to the cutting edge or to the body.

14. The method of claim 13, wherein the additional blade halves the bread slice.

15. The method of claim 13, wherein the cutting edge, the body, the handle, the additional blade, or a combination or sub-combination of the cutting edge, the body, the handle, and the additional blade comprise adjustably connected portions for changing the contour of the cutting edge.

16. The method of claim 1, wherein the bread slice is part of a stack comprising two or more bread slices.

17. The method of claim 16, wherein the crust trimmer further comprises an additional blade connected to the connected to the cutting edge for halving the bread slice.
